(19) United States
(12) Patent Application Publication
(10) Pub. No.: US 2010/0056048 A1
(43) Pub. Date: Mar. 4, 2010

(54) Supercapacitor Device For Ultra Low Frequency Transmission System

(75) Inventors: Michael Jorgensen, Jamesville, NY (US); Curt Andersson, Manlius, NY (US)

Correspondence Address: KING & SPALDING, LLP, 1100 LOUISIANA ST., STE. 4000, ATTN.: IP Docketing, HOUSTON, TX, 77002-5213, US

(73) Assignee: COOPER TECHNOLOGIES COMPANY, Houston, TX (US)

(21) Appl. No.: 12/202,930

(22) Filed: Sep. 2, 2008

(51) Int. Cl. H04B 7/00; H02J 7/00

(52) U.S. Cl. 455/41.2; 320/167

(57) ABSTRACT

Ultra low frequency transmissions can be used to penetrate obstructions to areas where other operation of other communication devices may be limited, such as in a mine, tunnel, or other underground location. A portable device that includes a supercapacitor, a transmitter, and an antenna can be used to communicate using ultra low frequency transmissions. In one aspect, a communication device comprises a supercapacitor; a transmitter powered by the supercapacitor; and an antenna connected to the transmitter for sending messages. In another aspect, a method for communicating comprises the steps of receiving a message to be transmitted, powering a transmitter from a charged supercapacitor, and transmitting the message via an antenna.

### TECHNICAL FIELD

The present application relates generally to systems and methods for utilizing supercapacitors to power devices for ultra low frequency-based radio transmissions.

### BACKGROUND

Communication devices such as cellular phones, pagers, radios, or other portable devices may not operate in many locations due to obstructions and/or lack of antennas for reception. For example, those devices may not operate in a building or other structure when obstructions such as walls and floors block transmissions from/to an antenna to/from a portable device. Additionally, those devices may not operate in an underground mine due to such obstructions, such as the ground, blocking the communications. If an individual or a group is trapped in a building or underground, especially in an emergency event where traditional communication systems are disrupted or otherwise obstructed, it can be very difficult or impossible to communicate with the trapped individual or group. Additionally, in the event of an emergency or other event, such as a power outage, fire, explosion, or other catastrophe, it can be difficult to communicate with first responders and/or personnel responding to the event within the building or underground.

One conventional communication system uses ultra low frequency pager communications for mines. Wires acting as an antenna are distributed on the surface above the mine and throughout the mines as it is excavated. Typically, such communication systems are designed for one-way communications from a transmitter located on the surface through the antenna to a receiver disposed at a fixed point in the mine or to a portable receiving unit carried by a miner. Because the power required to transmit ULF signals is very high, portable units typically do not have sufficient power to generate ULF signals that can communicate through obstructions, such as the ground or a building, to an antenna located on an opposite side of the obstruction. Accordingly, although miners may be able to receive messages, miners are not able to communicate back. Thus, trapped miners cannot communicate their location to potential rescuers.

Therefore, it is desirable to have a transmission system that can receive and transmit messages through obstructions when conventional communication devices are not operable or in an environment where conventional communications devices do not function.

### SUMMARY

Ultra low frequency transmissions can be used to penetrate obstructions to areas where other operation of other communication devices may be limited, such as a building, mine, tunnel, or other underground location. A portable device that includes a supercapacitor, a transmitter, and an antenna can be used to communicate using ultra low frequency transmissions. In an emergency, an operator can distribute the antenna across an area, and input a brief message into the transmitter. The operator can crank a handle on the supercapacitor to charge the supercapacitor. Then, the supercapacitor can provide a short-duration burst of energy to transmit the message in an ultra low frequency format via the distributed antenna.

In one aspect, a communication device comprises a supercapacitor; a transmitter powered by the supercapacitor; and an antenna connected to the transmitter for sending messages.

In another aspect, a method for communicating comprises the steps of receiving a message to be transmitted, powering a transmitter from a powered supercapacitor, and transmitting the message via an antenna.

These and other aspects, objects, and features of the invention will become apparent to those having ordinary skill in the art upon consideration of the following detailed description of exemplary embodiments exemplifying the best mode for carrying out the invention as presently perceived.

### BRIEF DESCRIPTION OF THE DRAWINGS

FIG. 1 illustrates a device for communicating using ultra low frequency transmissions according to an exemplary embodiment.

FIGS. 2a and 2b illustrate antenna extensions according to exemplary embodiments.

FIG. 3 illustrates an emergency ultra low frequency communication system according to an exemplary embodiment.

FIG. 4 illustrates a method for emergency communications using an ultra low frequency communication device according to an exemplary embodiment.

### DETAILED DESCRIPTION OF EXEMPLARY EMBODIMENTS

The invention may be better understood by reading the following description of non-limitative, exemplary embodiments with reference to the attached drawings wherein like parts of each of the figures are identified by the same reference characters.

Ultra low frequency transmissions can be used to penetrate obstructions to areas where other operation of other communication devices may be limited. A portable device that includes a supercapacitor, a transmitter, and an antenna can be used to communicate using ultra low frequency transmissions.

The exemplary embodiments described herein use ultra low frequency-based radio communications. Ultra low frequency is the frequency between about 300 hertz and 3 kilohertz. The size of the ultra low frequency wavelength can allow a transmission at this frequency to penetrate objects, such as walls of a building. Ultra low frequencies can have a small bandwidth, so the amount of data in a communication may be limited. As a result, an ultra low frequency communication may contain only text, although those communications can comprise other formats such as audio.

An ultra low frequency can penetrate through a building better than many other frequencies, such as those used by cellular telephones. The transmission is not a voice, but rather a transmission of characters in a textual format. Although the exemplary embodiment discusses a one-way textual communication, it is envisioned that the systems and methods could include two-way communications or other formats besides or in addition to text.

A person in a structure, such as a building, or a mine may desire to carry a portable device that allows communication in the event of an emergency or disaster. Although the device may be described herein as being portable, the device can be stationed throughout a structure or a mine and is not intended to be limited only to an embodiment where the device is carried by the individual. The device can include a supercapacitor, a transmitter, and an antenna.

Using the systems and methods described herein, the person can enter a message into the device. The device can then transmit the message using the communications system to rescue that person. For example, a trapped miner may enter a message explaining that there are certain number of miners alive and located at a certain post. Using a short burst of energy from the supercapacitor, the device can transmit this short message in just a few seconds.

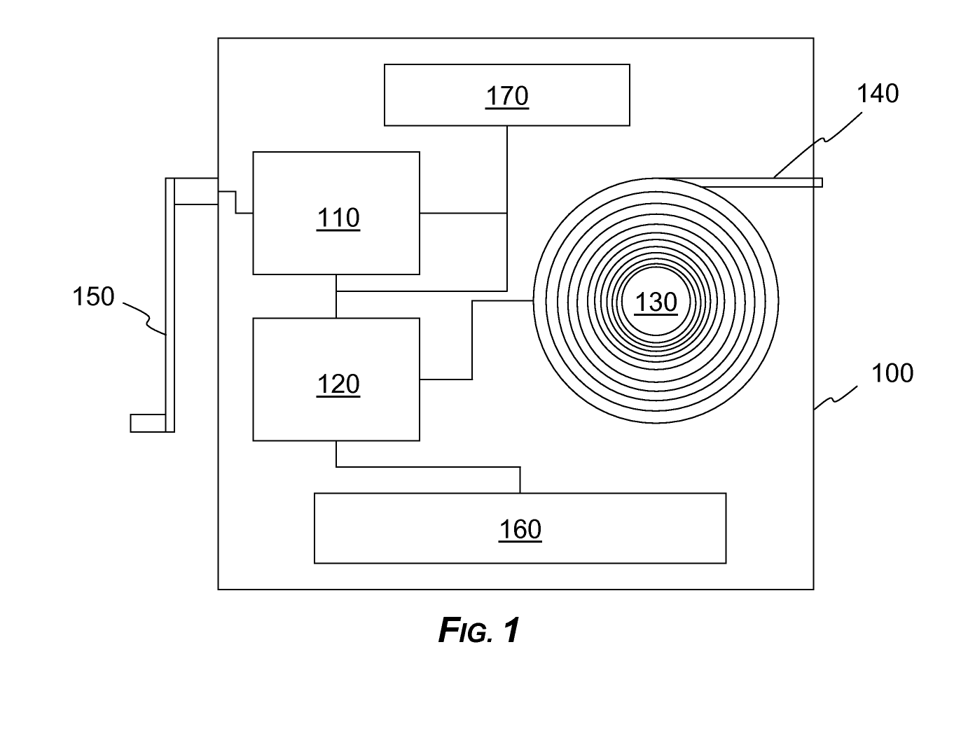

Referring to FIG. 1, an exemplary device 100 for communicating using ultra low frequency transmissions is illustrated. Device 100 includes a supercapacitor 110, a transmitter 120, a coiled antenna 130, a crank 150, a keyboard 160, and a display 170. Rotation of the crank 150 can provide power to the 110, which stores the power. The supercapacitor 110 can provide power to the transmitter 120 to allow an operator to input a message into the transmitter 120 via the keyboard 160. The message and/or operating instructions can be displayed on the display 170. The supercapacitor 110 further powers the transmitter 120 to communicate the message via the antenna 130. The antenna 130 can be uncoiled from the device 100 by extending an antenna portion 140. Alternatively or in addition to the keyboard 160, other types of input devices, such as a microphone, can be used to enter a message, such as an audio message, into the device. The display 170 or other output device can show an incoming and/or outgoing message.

Supercapacitors can be used as a high power energy source to drive a portable ultra low frequency-based radio transmission system. To transmit a message, the transmission system may demand high power. However, due to the portability of the transmission system, an energy supply may be limited. A supercapacitor can act as a high capacity energy supply.

A supercapacitor, also known as an ultracapacitor or an electrochemical double-layer capacitor, is an electrochemical capacitor that has a high energy density when compared to conventional capacitors. Aerogel supercapacitors incorporate the high energy density of batteries and the high power of conventional capacitors. An electric double layer is formed at the interface of a solid carbon electrode, such as aerogel carbon, and a liquid electrolyte. The supercapacitor can store energy electrostatically between the solid electrode and oppositely charge electrolyte ions that migrate towards the electrode when a potential is applied. The electrode can contain many internal pores, which creates a large surface area. The energy can be stored as a charge or concentration of electrons on the surface of the material. Unlike some other types of batteries, supercapacitors do not undergo a chemical reaction when charged. Because the charge can be stored on the surface area, the supercapacitor can charge quickly, operate at low temperatures, and have a large number of charge-discharge cycles.

A crank can be used to power the supercapacitor. A user can operate the crank to gain sufficient power to input and transmit a message. Alternatively, the supercapacitor can be charged directly from a battery. Although the exemplary embodiment recites a crank, it is not intended to be limited to only that particular configuration.

The transmitter is powered by the supercapacitor. The transmitter can transmit messages entered from the keyboard or other input device and send those messages over the antenna. Optionally, the transmitter also can include a receiver for receiving messages from via the antenna for depicting on the display or other output device.

The device can include an antenna attached to the transmitter. The antenna can be configured to be coiled inside the device for storage. When the device is to be used, the antenna can be uncoiled and unwound by pulling the antenna from the device.

It may be desirable for the antenna to extend as long as possible to provide the highest signal output available from the antenna. The antenna length may be based on the strength of the transmitter or a desired application. For example, the antenna may extend about 100 meters. In other embodiments, the antenna may extend about 50 meters or 200 meters. In certain other embodiments, the antenna may extend about 10 meters. These lengths are intended to be merely exemplary and the antenna is not intended to be limited to a particular length.

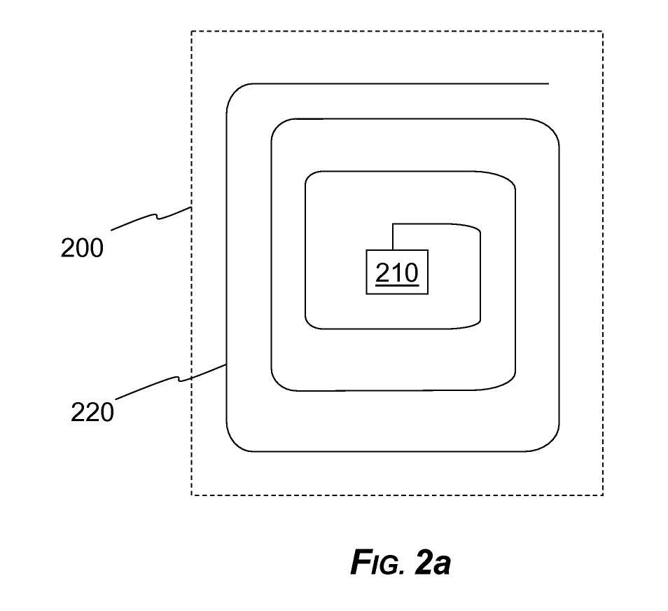

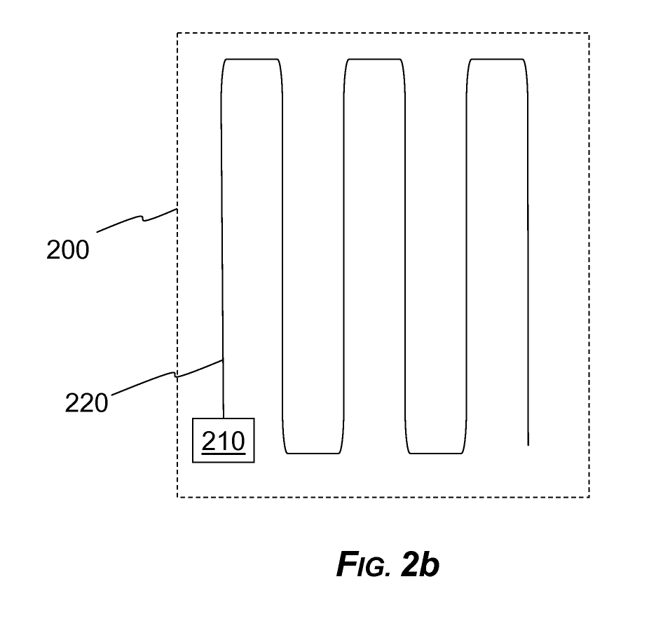

In a trapped section of a mine or a tunnel, the antenna can be extended throughout the confined area. It may be desirable to extend the entire antenna. For example, referring to FIG. 2a, in an area 200, such as where an individual may be trapped or located, an antenna 220 extending from a device 210 can be wrapped in substantially concentric loops to obtain the greatest coverage with the antenna 220.

Referring to FIG. 2b, in an area 200, an alternative extension of an antenna 220 extending from device 210 is illustrated. In this configuration, antenna 220 is extended back-and-forth across the area 200, as opposed to concentric circles. The use of antenna 220 is not limited to any extended configuration, however, and the configurations illustrated in FIGS. 2a and 2b are intended to be merely exemplary of how antenna 220 can be extended to maximize reception and transmission within the area 200.

Although the exemplary embodiments described herein recite the transmission of a message from the device, it is intended that alternative embodiments include the capability to receive messages using the antenna and displaying or outputting those messages to a user.

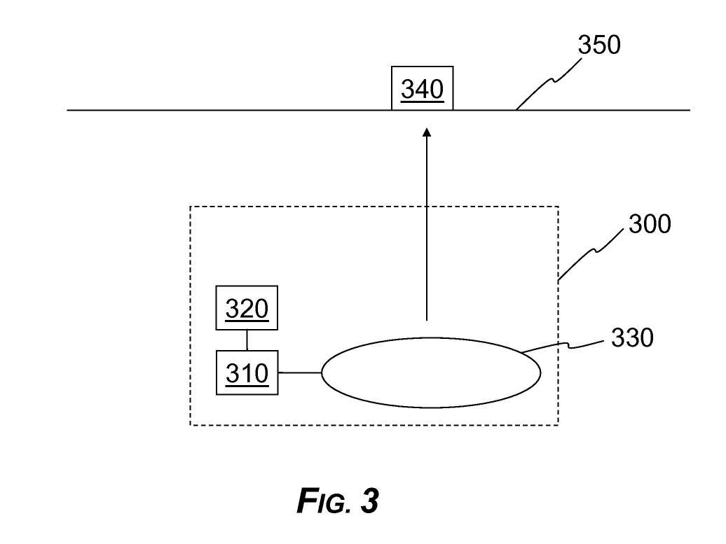

In an exemplary embodiment, a safe location within a mine can include a transmitter for sending messages to rescue personnel. Referring to FIG. 3, an exemplary emergency ultra low frequency communication system is illustrated. A shelter 300 located underground, such as in a mine or a tunnel, can include an ultra low frequency transmitter 310 powered by a supercapacitor 320. The transmitter 310 can send a message entered by an input device (not shown), such as a keyboard, or can send a preexisting message that can be optionally selected. Additionally, an optional display can show the message to be transmitted to the operator. The transmitter 310 transmits the message using an ultra low frequency antenna 330 that can be wrapped around or spread across the shelter 300 or outside the shelter 300 as space permits. In one exemplary embodiment, an operator can arrange the antenna configuration before use. In another embodiment, the shelter can be pre-wired with a desirable antenna configuration. The antenna 330 can transmit messages from the transmitter 310 to a receiver 340 on a ground surface 350. In an alternative embodiment, the shelter 300 can be configured to receive messages by including a receiver coupled to the antenna 330. In an exemplary embodiment, the transmitter 310 can comprise the receiver.

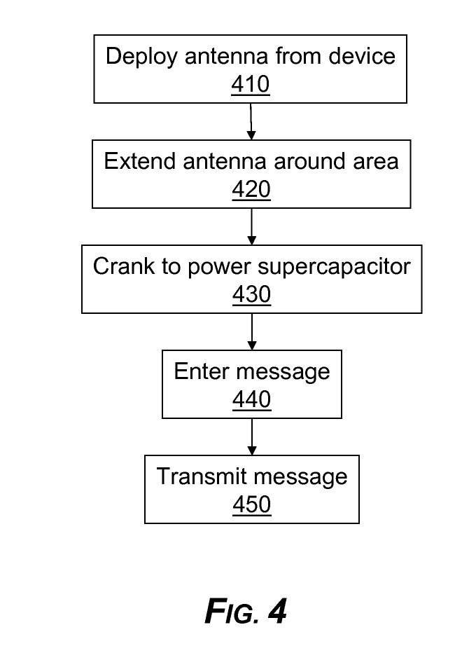

Referring to FIG. 4, a method for emergency communications using an ultra low frequency communication device is illustrated. An antenna can be deployed from a portable device, step 410. The antenna can be extended around the area, step 420. A crank can be used to power the supercapacitor, step 430. The supercapacitor can be powered at any time during this exemplary process. A message can be entered, step 440. The transmitter can transmit the message through the antenna, step 450, using power from the supercapacitor.

In an alternative exemplary embodiment, the portable device can be used in a large building or other structure. In an emergency, an operator can operate the device as described previously with reference to mine operations to communicate a message in an ultra low frequency format. The message can identify the number of people in the building and their location, thereby allowing rescuers to find them more quickly.

Therefore, the invention is well adapted to attain the ends and advantages mentioned as well as those that are inherent therein. The particular embodiments disclosed above are illustrative only, as the invention may be modified and practiced in different but equivalent manners apparent to those having ordinary skill in the art and having the benefit of the teachings herein. While numerous changes may be made by those having ordinary skill in the art, such changes are encompassed within the spirit and scope of this invention as defined by the appended claims. Furthermore, no limitations are intended to the details of construction or design herein illustrated, other than as described in the claims below. It is therefore evident that the particular illustrative embodiments disclosed above may be altered or modified and all such variations are considered within the scope and spirit of the present invention as defined by the claims below. The terms in the claims have their plain, ordinary meaning unless otherwise explicitly and clearly defined by the patentee.

What is claimed is:

1. A communication device, comprising:
a supercapacitor;
a transmitter powered by the supercapacitor to transmit a message; and
an antenna connected to the transmitter, the antenna being configurable into an array for communicating the message received from the transmitter.

2. The device according to claim 1, wherein the transmitter transmits via the antenna using ultra low frequency-based radio transmission.

3. The device according to claim 1, further comprising a crank for powering the supercapacitor, wherein the supercapacitor stores a charge generated by movement of the crank.

4. The device according to claim 1, wherein the supercapacitor comprises an aerogel carbon electrode.

5. The device according to claim 1, further comprising a receiver connected to the antenna for receiving messages via the antenna.

6. The device according to claim 5, wherein the receiver is powered by the supercapacitor.

7. The device according to claim 1, further comprising a keyboard for inputting a message to be transmitted into the device.

8. The device according to claim 1, further comprising a display for showing a message to be transmitted.

9. The device according to claim 1, wherein the antenna is substantially wound within the device, and wherein the antenna is configured to be unwound for use as an antenna.

10. The device according to claim 1, wherein the device is portable.

11. The device according to claim 1, wherein the antenna has a minimum length of fifty meters.

12. A method for communicating, comprising the steps of:
receiving a message to be transmitted;
powering a transmitter from a powered supercapacitor; and
transmitting the message via an antenna.

13. The method according to claim 12, further comprising the step of charging the supercapacitor.

14. The method according to claim 13, wherein the step of charging the supercapacitor comprises operating a crank.

15. The method according to claim 12, further comprising the step of deploying the antenna.

16. The method according to claim 12, further comprising the step of extending the antenna around an area.

17. The method according to claim 12, further comprising the step of displaying the message to be transmitted.

18. The method according to claim 12, further comprising the step of receiving a keyboard input of the message to be transmitted.

19. The method according to claim 12, wherein the message is transmitted using ultra low frequency-based radio transmissions.

20. The method according to claim 12, further comprising the step of receiving a message from the antenna.

21. The method according to claim 20, further comprising the step of displaying the received message.
